(19) United States
(12) Patent Application Publication
(10) Pub. No.: US 2014/0180719 A1
(43) Pub. Date: Jun. 26, 2014

(54) PERSONAL HEALTHCARE INFORMATION MANAGEMENT SYSTEM AND RELATED METHODS

(71) Applicants: Lorree Bell, Cadiz, KY (US); Richard Cales, Louisville, KY (US)

(72) Inventors: Lorree Bell, Cadiz, KY (US); Richard Cales, Louisville, KY (US)

(73) Assignee: MYMEDLINK, LLC, Cadiz, KY (US)

(21) Appl. No.: 14/057,751

(22) Filed: Oct. 18, 2013

Related U.S. Application Data
(60) Provisional application No. 61/716,553, filed on Oct. 21, 2012.

(51) Int. Cl. G06Q 50/24; G06F 19/00

(52) U.S. Cl. CPC G06Q 50/24; G06F 19/322
USPC 705/3

(57) ABSTRACT

Embodiments may include patient-administered systems for managing personal healthcare information. A patient may be enabled to control the content of a patient-controlled database, and may control the access of others to the data contained therein. Optionally, some embodiments of the invention may include one or more of a means for authorized users of the system to communicate with each other, a patient-controlled database configurable to communicate data between itself and a remote third party data source, a personal log tool for manually or automatically inputting data, or a means for detecting problems with drug prescriptions and reporting the problems to the patient.

### I. BACKGROUND OF THE INVENTION

A. Field of Invention

Some embodiments may generally relate to management of electronic personal healthcare records by patients.

B. Description of the Related Art

Electronic medical records and systems for managing them are known in the art. However, existing systems have a number of shortcomings. Many of these problems result from the fact that people tasked with data entry do not have sufficient motivation to ensure accuracy, and may not have the insight or the information available to identify problems or gaps in the data. Problems with accuracy and completeness of the data are compounded by the fact that data entry is decentralized. Multiple institutions may enter data into, for instance, a health information exchange system. For instance, the various entities involved may include a primary care physician, an emergency room, a neighborhood pharmacy, a hospital pharmacy, medical test labs, and so on. Thus, multiple loosely related entities are inputting and managing personal electronic health records. While existing systems are not without crosschecks, what is missing is data validation by the ultimate consumer of healthcare services, i.e. the patient.

Another problem with existing systems is that they are not oriented toward the patient and do nothing to facilitate accurate communication of critical healthcare information to persons who may need it such as a family member who must interact with healthcare personnel on behalf of the patient, personal caregivers, or first responders dealing with a patient's medical emergency. Conveying inaccurate, incomplete, or out-of-date information in an emergency could be more harmful than providing no information at all. Present systems provide no means at all for non-medical personnel to have access to information that they can rely on as being timely and accurate.

Some embodiments of the present invention may provide one or more benefits or advantages over the prior art.

### II. SUMMARY OF THE INVENTION

Some embodiments may relate to a patient-administered personal healthcare information management system, comprising: at least one patient-controlled database containing personal healthcare information of a patient, wherein the patient controls the data content of the at least one patient-controlled database; a patient-controlled means for creating new user accounts; a set of access level permissions of user accounts adapted to control access of the user accounts to data contained in the at least one patient-controlled database; and at least one communications feature adapted to allow user accounts to communicate with each other according to a set of predefined communications permissions.

According to some embodiments the user accounts each comprise a User Classification data structure including one or more access level permissions and one or more communications permissions.

According to some embodiments User Classification data structures are grouped into templates according to like sets of access level permissions and according to like sets of communications permissions.

According to some embodiments the set of access level permissions are configurable by the patient.

Embodiments may also include a patient-controlled means for configuring the set of communications permissions.

According to some embodiments the at least one communications feature is selected from one or more of a blog, a wiki, an electronic bulletin board, a profile page adapted to include electronic posts, text chat, SMS text messaging, electronic mail, shareable calendaring software, shareable appointment scheduling software, RSS feeds, video conferencing, voice-over-IP, or conference calling.

Embodiments may also include at least one third party personal healthcare information data source selectable by the patient for placing in electronic data communication with the at least one patient-controlled database, the at least one patient-controlled database being adapted to record and store personal healthcare information data from at least one selected third party personal healthcare information data source.

According to some embodiments the at least one third party personal healthcare information data source comprises a health information exchange service, and wherein the at least one third party personal healthcare information data source comprises a plurality of data streams, the data streams being individually selectable by the patient.

Embodiments may also include a dashboard including selected personal healthcare information data from the at least one patient-controlled database and/or one or more summaries of personal healthcare information data from the database.

Embodiments may also include a means for issuing alert notices to users designated by the patient, wherein alerts may be issued through one or more of a patient user account, non-patient user accounts authorized by the patient to issue alerts, and/or automatically by the system according to predetermined criteria, and wherein the alerts may be received by users authorized by the patient to receive alerts, and/or may be received by users authorized by virtue of their access level permissions to receive alerts.

Embodiments may also include a means for detecting problems with drug prescriptions and reporting the problems to the patient and/or one or more users selected by the patient.

According to some embodiments the means for detecting identifies drug prescription problems by analyzing at least data contained in the patient controlled database.

Embodiments may also include a personal log tool adapted for recording by the patient of health parameters selected from one or more of vital signs, body weight, blood sugar, heart rate, or blood pressure, wherein the personal log tool comprises pre-formatted data fields for receiving data measurable in predetermined units and/or as a function of time.

According to some embodiments the personal log tool is adapted to receive manually inputted data, and/or automatically receive data from an external electronic measuring device according to a predetermined electronic communications protocol.

According to some embodiments the manually or automatically inputted data are recorded in the patient-controlled database and communicated to a physician user account, or to a physician external to the system.

Embodiments may also include a means for providing emergency access to data selected for emergency access according to likely emergency needs.

Some embodiments may generally relate to a patient-administered personal healthcare information management system, comprising: at least one patient-controlled database containing personal healthcare information of a patient, wherein the patient controls the data content of the at least one patient-controlled database; a patient-controlled means for creating new user accounts; a set of access level permissions of user accounts adapted to control access of the user accounts to data contained in the at least one patient-controlled database; and at least one third party personal healthcare information data source selectable by the patient for placing in electronic data communication with the at least one patient-controlled database, the at least one patient-controlled database being adapted to record and store personal healthcare information data from at least one selected third party personal healthcare information data source.

Some embodiments may generally relate to a patient-administered personal healthcare information management system, comprising: at least one patient-controlled database containing personal healthcare information of a patient, wherein the patient controls the data content of the at least one patient-controlled database; a patient-controlled means for creating new user accounts; a set of access level permissions of user accounts adapted to control access of the user accounts to data contained in the at least one patient-controlled database; and a personal log tool adapted for recording by the patient of health parameters selected from one or more of vital signs, body weight, blood sugar, heart rate, or blood pressure, wherein the personal log tool comprises pre-formatted data fields for receiving data measurable in predetermined units and/or as a function of time.

Some embodiments may generally relate to a patient-administered personal healthcare information management system, comprising: at least one patient-controlled database containing personal healthcare information of a patient, wherein the patient controls the data content of the at least one patient-controlled database; a patient-controlled means for creating new user accounts; a set of access level permissions of user accounts adapted to control access of the user accounts to data contained in the at least one patient-controlled database; and a means for detecting problems with drug prescriptions and reporting the problems to the patient and/or one or more users selected by the patient.

Some embodiments may generally relate to a patient-administered personal healthcare information management system, comprising: at least one patient-controlled database containing personal healthcare information of a patient, wherein the patient controls the data content of the at least one patient-controlled database; a patient-controlled means for creating new user accounts; a set of access level permissions of user accounts adapted to control access of the user accounts to data contained in the at least one patient-controlled database; at least one communications feature adapted to allow user accounts to communicate with each other according to a set of predefined communications permissions; at least one third party personal healthcare information data source selectable by the patient for placing in electronic data communication with the at least one patient-controlled database, the at least one patient-controlled database being adapted to record and store personal healthcare information data from at least one selected third party personal healthcare information data source; a personal log tool adapted for recording by the patient of health parameters selected from one or more of vital signs, body weight, blood sugar, heart rate, or blood pressure, wherein the personal log tool comprises pre-formatted data fields for receiving data measurable in predetermined units and/or as a function of time, wherein the personal log tool is adapted to receive manually inputted data, and/or automatically receive data from an external electronic measuring device according to a predetermined electronic communications protocol; and a means for detecting problems with drug prescriptions and reporting the problems to the patient and/or one or more users selected by the patient.

Other benefits and advantages will become apparent to those skilled in the art to which it pertains upon reading and understanding of the following detailed specification.

### III. BRIEF DESCRIPTION OF THE DRAWINGS

The invention may take form in certain parts and arrangement of parts, embodiments of which will be described in detail in this specification and illustrated in the accompanying drawings which form a part hereof and wherein:

FIG. 1 is a schematic representation of an embodiment interacting with remote third party data sources and with remote users;

FIG. 2 is a schematic representation of a plurality of healthcare professionals interacting with a healthcare information exchange, and an embodiment retrieving data that they input;

FIG. 3 is a schematic representation of a plurality of users of an embodiment including healthcare professionals, the patient, and caregivers, remotely interacting with the embodiment;

FIG. 4A is an illustration of a Patient User Classification;

FIG. 4B is an illustration of a Primary Care Doctor User Classification;

FIG. 4C is an illustration of an Emergency Contact User Classification;

FIG. 5 is an illustration of a profile page of an embodiment including social media features;

FIG. 6 is an illustration of a wiki of an embodiment;

FIG. 7 is a schematic representation of a drug validation system of an embodiment; and

FIG. 8 is a schematic representation of a vital sign monitoring and journaling feature of an embodiment.

### IV. DETAILED DESCRIPTION OF THE INVENTION

As used herein the terms “embodiment”, “embodiments”, “some embodiments”, “other embodiments” and so on are not exclusive of one another. Except where there is an explicit statement to the contrary, all descriptions of the features and elements of the various embodiments disclosed herein may be combined in all operable combinations thereof.

Language used herein to describe process steps may include words such as “then” which suggest an order of operations; however, one skilled in the art will appreciate that the use of such terms is often a matter of convenience and does not necessarily limit the process being described to a particular order of steps.

Conjunctions and combinations of conjunctions (e.g. “and/or”) are used herein when reciting elements and characteristics of embodiments; however, unless specifically stated to the contrary or required by context, “and”, “or” and “and/or” are interchangeable and do not necessarily require every element of a list or only one element of a list to the exclusion of others.

As used herein, the term “patient-controlled database” is not limited to a single database, but rather may include a plurality of databases controlled by a patient.

As used herein the term “User Classification” includes data structures adapted to organize and/or contain data defining an authorized user account and/or an authorized user's level of access to an embodiment. This term may include one or more parameters for setting the level of access of an authorized user account to an embodiment.

As used herein the terms “access level” and “access level permissions” include a set of policies and/or parameters determining the data and features of an embodiment available to an authorized user account.

Some embodiments generally relate to a patient-administered electronic healthcare records (EHR) system and/or method enabling an individual patient to manage and control access to his or her own medical record data, e.g. a Personal Health Record (PHR). Embodiments may include a means for downloading data from a remote data source such as, without limitation, a health information exchange (HIE), a medication reconciliation service, and/or a diagnoses data source. Embodiments may further include means for recording the data, or at least a portion thereof, in a patient-controlled database. Embodiments may enable a patient to grant controlled access to selected entities such as, without limitation, a doctor, a pharmacy, a caregiver, or anyone to whom the patient wishes to grant access. Embodiments may also provide a means for certain entity types to unilaterally gain emergency access according to predetermined criteria. For instance, a patient may preauthorize any entity to access his or her patient-controlled data if the entity is an emergency medical provider and it is responding to or managing an emergency situation in which the patient is involved.

Embodiments may include means for communicating with a remote commercial healthcare data source(s) which is not managed by the patient. For instance, such a healthcare data source may include one or more of a health information exchange, a prescriptions database, a database of medical test data, medical diagnosis records, a hospital records database, an insurance coverage database, or similar databases of which one skilled in the art would be aware. Such remote third party data sources may be populated with data from one or more of pharmacies, doctors, hospitals, insurance companies, medical test labs, emergency responders, and the like. A means for communicating with a remote third party data source, such as a commercial healthcare data source, may include controls adapted to be used by a patient to select data streams, to set update frequency, to allow or disallow push protocols, to select communication protocols and/or encryption algorithms, to set access level permissions, and to set any other parameters for communicating with a remote third party data source. Furthermore, a means for communicating with a remote third party data source may also include means for downloading, storing, and managing data downloaded therefrom.

Data in a remote healthcare data source, such as that of a health information exchange, may be downloaded to a database which is under the control of a patient. Furthermore, according to some embodiments such downloads may occur automatically. For instance, an embodiment may initiate downloads according to a predetermined schedule and/or at a predetermined interval. Embodiments may also receive data according to a push protocol from a remote third party data source as, for instance, the third party data source is updated. Thus, a patient-controlled database may or may not be updated and/or synchronized in real time, or near real time.

A patient may determine the data with which his or her database is populated and/or synchronized. For instance, a patient may select a particular health information exchange database(s), and/or may select particular data streams from such databases such as, without limitation, prescription drug data, dietary supplement data, historical patient health data, current health condition data, allergies data, diagnostic test data, diagnosis data, course-of-treatment data, insurance data, insurance coverage data, treatment results data, and the like. Thus, the specific nature of data contained in the patient-controlled database can include, without limitation, any of the data from the foregoing selected data sources as well as data manually inputted by the patient such as health journal data, vital signs, insurance data, copies of living wills, wishes and directives regarding medical care, organ donor data, emergency contacts, contact information for a legal guardian(s), details of the specific nature and scope of authority of a guardian and/or attorney-in-fact, other health-related legal documents, and the like.

The nature of the patient's control may include, without limitation, granting access to selected individuals or entities, controlling the access level of those granted access to the data, selecting the kind of data and/or the specific data recorded in the database, editing data belonging to one or more predetermined categories, and manually adding data such as historical journal data, logs of vital signs, body weight, blood pressure, blood sugar and the like. A patient may also select particular communications means which are accessible to a particular user or class of users. For instance, some users may be allowed to use text chat services to communicate with other patient-authorized users, but may not be allowed to issue alerts. Similarly, some patient-authorized users may be able to communicate only with users in patient-defined groups. For instance, family and friends may be able to communicate with each other, but may require special access to communicate with medical professionals.

As previously mentioned, a patient may select particular data sources and/or data streams within a data source, and may similarly grant access to selected data within his or her database. For example, some authorized users may only need access to prescription data, and may not need diagnostic test data; accordingly, a patient may grant that user access only to prescription data. Other authorized users such as a primary care doctor may require full access to all of the patient's records, therefore the patient may grant full access to such authorized users. Embodiments may include predefined User Classifications which include predefined default access level permissions so that a user can assign access levels to users by assigning them to a User Classification. For example, an Owner (or Patient) User Classification may have read/write access to all data, may have the power to reconfigure settings, and may have full access to communications features such as text chat, issuing alerts, publishing posts in a wiki or blog of an embodiment, or otherwise using communications features of an embodiment to communicate with other authorized users. In contrast, a Doctor User Classification may have read/write access to most data, and full access to communications features, but read-only access to healthcare directives, and may not have the power to reconfigure system settings. Still further, a Family or Friend User Classification may have read-only access to a limited predetermined subset of data and may not be able to use communications features of the embodiment to communicate with medical professionals.

According to some embodiments, a User Classification may define a data structure adapted to contain and/or organize data pertaining to particular authorized users. Such a data structure may have predetermined access level permissions which control the data a user is permitted to read and write, and the features the user is permitted to use; however, embodiments may enable the patient to modify predetermined access level permissions. A user classification data structure may also include individually identifiable data such as user name, legal name, residential address, telephone number, email address, and so on. User Classification data structures may be grouped into templates according to like settings. Thus, an Emergency Contact User Classification template may exist whereby all emergency contacts are assigned the same sets of permissions.

In some embodiments, new authorized user accounts may be created by a patient. For instance, an embodiment may include a means for the patient to create an account having a predetermined User Classification, and issue an invitation to an individual that he/she wishes to become an authorized user. Thus, the individual's permissions are predetermined by the patient. In other embodiments, a potential authorized user may create an account initially having no access or very limited access to an embodiment, and the patient may then be notified by the embodiment and given the option to approve the user and set the User Classification, or to deny the request.

The patient's database may include a means for processing and/or presenting data to patient-authorized users of the system. For instance, a patient's database may include one or more reports which list, summarize, categorize or otherwise present data to an authorized user. One report may be an insurance carrier summary report enumerating data which would be necessary for a hospital or other provider to obtain payment. Another report may comprise a medications report showing all of the current prescription and/or nonprescription drugs that the patient is taking. Still another report may show how a selected parameter such as blood pressure or body weight changed over time and/or in response to one or more therapeutic drugs or exercise regimes. Some embodiments may provide authorized users with a means for generating custom reports. Furthermore, reports may be printable and may be specially formatted for being readily printed. For instance, an embodiment may include a printable report for generating a pocket-size or business card-size list of medications and allergies which the patient can print out and carry for ready access in an emergency. Embodiments allowing for emergency responder access may include a report containing all information likely to be needed in a medical emergency. One skilled in the art will recognize that a wide variety of reports are possible and may be appropriate depending on the specific questions which an authorized user wishes to answer. Some embodiments may include one or more dashboards which provide quick access to summary data relative to the patient.

Means of accessing a patient's database or information contained therein can include any of a wide variety of communications devices, protocols, and media combinations including without limitation, the Internet, telephonic media, wireless data protocols such as Wi-Fi or Bluetooth, a purpose-built device held by an individual for accessing an embodiment, a suitably programmed smart phone, tablet computer, or personal digital assistant, or even specially adapted printouts of data from the patient's database, and so on or any combination thereof. Communication may be unidirectional, bidirectional, or a hybrid, and may be synchronous or asynchronous.

A data link may be securely established according to any of a wide variety of security methodologies, protocols, and devices known in the art. For example, a password or security code may be necessary for establishing a data link, and once established all data transmissions may be encrypted through a secure socket layer or other encryption means. Data transmission may be formatted according to data interchange standards such as those set out by the National Counsel of Prescription Drug Programs (NCPDP), the American Society for Testing and Materials (ASTM), the Centers for Medicaid & Medicaid Services (CMS), and/or the Office of the National Coordinator for Health Information Technology (ONC). Such data interchange standards may be specifically compliant with Health Information Technology for Economic and Clinical Health (HITECH) Act and/or the American Recovery and Reinvestment Act of 2009.

Embodiments may include one or more means for communicating data from the patient-controlled database to one or more authorized users, and/or for communicating data from one authorized user to one or more other authorized users. Such communications means can include one or more of SMS text messaging, chat, posting messages to a feed, voice-over-IP (VOIP), video conferencing, automated telephone calls with prerecorded messages, known broadcast messaging protocols, electronic mail, electronic mailing lists, electronic bulletin boards, blogs, wikis, and other known communications means.

One example of a means for communicating data from one authorized user to another can include pushing alerts, e.g. via email or telephone, to one or more authorized users. For instance, if the patient is involved in a medical emergency, an emergency responder interacting with an embodiment may cause an alert to be sent to a spouse, parent, adult child, and/or other emergency contact. The recipient(s) of such an alert may be predetermined by the patient. For example, the patient may appoint alert recipients individually, and/or such appointment may be associated with a User Classification such as that of Emergency Contact, or Primary Care Physician.

Alerts according to embodiments of the invention may be triggered upon the occurrence of a predetermined event such as the patient being admitted to a hospital, or the patient's monitored vital signs meeting certain predetermined criteria. According to some embodiments, alerts may be manually triggered by an authorized user interacting with a control for issuing alerts. For instance, a control such as an appropriately labeled virtual button may be provided in an embodiment whereby an emergency responder may issue an emergency alert to the patient's predetermined emergency contact(s) by gaining emergency access to the embodiment and interacting with the button.

Embodiments may include alerts having predefined message content and may or may not be editable by authorized users having suitable access level permission. Furthermore, alerts may be configured or configurable to (1) be disseminated to predetermined recipients, and (2) include indicia prominently identifying the nature of the alert as, for instance, a reminder, an emergency, an indication of the patient's health status, and so on. A reminder alert indicating that the patient has a prescription overdue for pickup may be issued only to the patient or to a caregiver to whom prescription pick-up has been delegated, and the alert may be configured with appropriate visual and/or audible indicia to prominently indicate that it communicates a non-emergency situation. Alternatively, an emergency alert indicating that the patient has been admitted for emergency medical attention may be issued to one or more emergency contacts, and may be configured to prominently indicate an emergency situation.

Embodiments may include one or more means for authorized users to communicate with each other. In one non-limiting example, a physician or an agent thereof may interact with an insurance carrier of the patient in real time to determine eligibility or to clarify the nature of a service being provided to determine eligibility. Such an interaction may be through a text chat or instant messaging service, voice chat, voice over IP, or other communications technologies known in the art. In some embodiments, a patient may enable or disable communication between selected authorized users or User Classifications.

Similar forms of communication may connect, for example, a pharmacy to a prescribing physician, an emergency responder to a primary care doctor, a triage nurse to an operating room, a doctor to a patient, or one medical specialist to another. Embodiments may also include means for communicating appointments with providers or reminders of such appointments. For instance, a primary care doctor may use components of an embodiment to schedule a patient for medical testing and communicate the appointment to both the testing facility and the patient. In one example, such an embodiment may include providing each party with a meeting invitation and/or placing the appointment on calendars of the respective parties. According to some embodiments, an example of a reminder can include reminding a patient to refill a medication or to take a medication, and may or may not further provide the patient with a means for recording completion of such a task.

Embodiments may also include means for patients to interact with each other. In one example, such interaction may include a discussion groups, links to blogs on topics medically relevant to the patient. In some embodiments, a patient may be provided with an electronic space such as a profile page equipped wherein the patient may choose to populate the site with content derived from the patient's database. An electronic space be provided to some or all other authorized users of an embodiment and may include social media features whereby the users may interact with each other, post content, link to content, and/or vote. A content management system may provide the patient with means for setting access restrictions on who can view selected data or data streams from the patient's database, and control the content posted or linked to by authorized users.

Some embodiments may provide for special access to emergency services and/or emergency medical personnel. One example of special access may include providing an emergency access code to emergency service providers. For instance, a token may be electronically issued to an emergency responder to gain emergency access. Emergency access codes may be static or may change from time to time. According to some embodiments, a patient may carry an access code in the format of a business card or credit card which an emergency responder could use to access the patient's database. In other embodiments a single emergency access code, e.g. “911”, may be used to access all electronic medical records of any patient using an embodiment.

In other embodiments, an emergency responder may gain access by (1) affirmatively stating in a recorded form that he/she is responding to an emergency, and (2) providing indicia, such as biometric indicia or voiceprint, that can unambiguously identify the responder and track his/her data access behaviors.

In still other embodiments, patients' emergency access codes may be contained in a centralized secure database, and the database may be provided to emergency service providers, or access to the database may be provided. In one embodiment emergency service providers may each have a unique account with unique login credentials which provides them with access to the secure database containing emergency access codes. For security purposes, the emergency access codes for individual patient-controlled electronic medical record databases may be automatically changed from time to time.

Users gaining access through emergency means, e.g. emergency medical technicians, may have access that is limited to a predetermined subset of data that is deemed likely to be necessary for managing most medical emergencies. Such a subset of data may include current medications, current health conditions, and blood type. Other sensitive information such as insurance data, social security number, or home address may not be accessible or may be masked to mitigate the risk of identity theft.

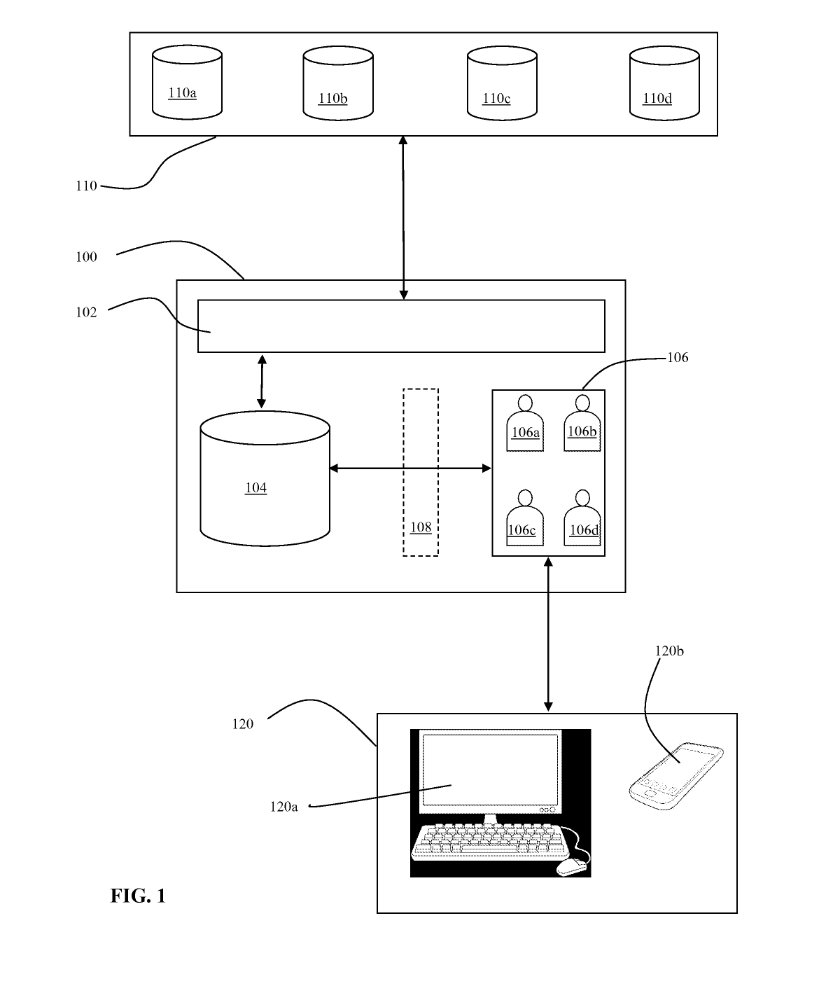

Referring now to the drawings wherein the showings are for purposes of illustrating embodiments of the invention only and not for purposes of limiting the same, FIG. 1 is a schematic drawing showing an overall view of an embodiment 100. The embodiment 100 is shown in bidirectional communication with a plurality of third party data sources 110. The individual third party data sources 110a-d communicate with a patient-controlled database 104 according to a set of communications rules 102. The communications rules 102 may be configurable by the patient. For example, a patient may select one or more data streams from database 110a and 110c to populate the patient-controlled database 104. The communications rules 102 may also enable a patient to set the frequency at which the embodiment polls remote data sources for data updates and/or may enable a patient to accept updates through a push protocol. The communications rules 102 may further include data management rules which control digital record retention and destruction policies, data audit records, and/or access level permissions.

As shown in FIG. 1, a set of authorized users 106 may have access to the patient-controlled database 104 according to predetermined access level permissions granted to the individual authorized users 106a-d. For instance, authorized user 106a may be the patient, i.e. the owner of the personal healthcare records contained in the database. Therefore, user 106a may have full access to all data in the database 104 and may also have the power to configure the data communications rule 102. In contrast, authorized user 106b may be the patient's primary care doctor, and therefore may have access to all or nearly all of the data contained in the patient-controlled database 104, but may not have the power to configure data communications rules 102. Optionally, the embodiment 100 may include a separate means for controlling the access of authorized 106 users to the patient-controlled database 108 apart from the data communications rules 102.

Further according to FIG. 1, authorized users 106 may interact with the embodiment 100 through Internet enabled devices 120. For example, one may use a smartphone 120b or a personal computer 120a to interact with an embodiment 100. One skilled in the art will appreciate that these are merely examples of suitable devices and is not intended to be limiting. Other suitable devices may include a purpose-built electronic communications device dedicated to interacting with embodiments of the invention.

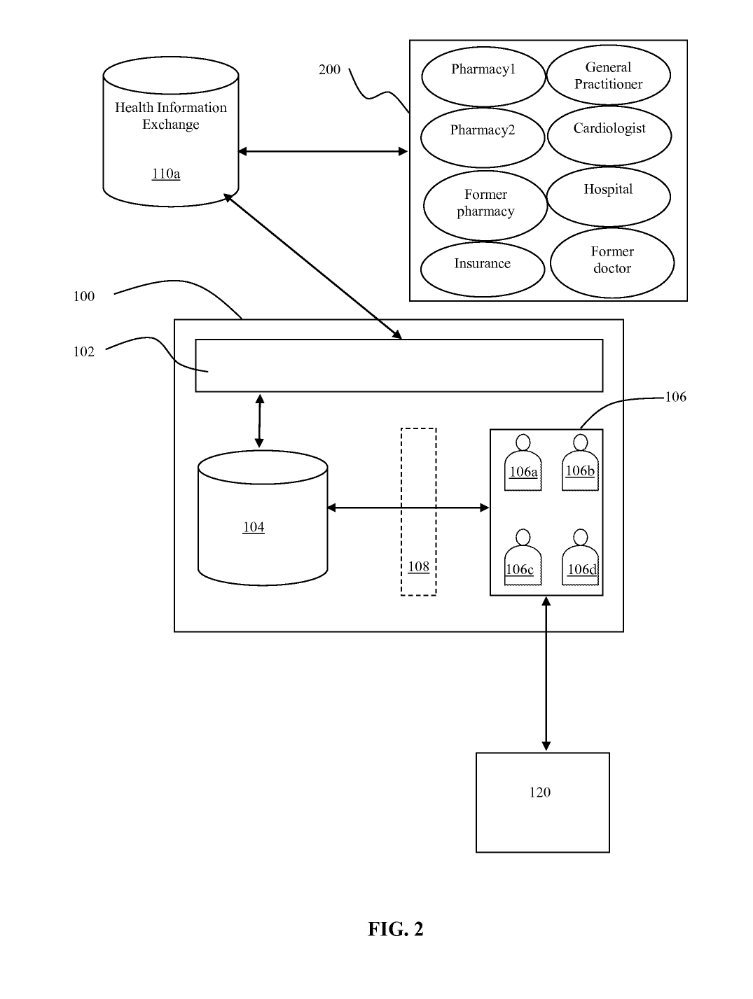

FIG. 2 illustrates an example where a third party data source 110a is a health information exchange (HIE). According to FIG. 2, various health professionals and healthcare institutions interact with the health information exchange. For instance, a primary care doctor may input prescriptions into the HIE, and a pharmacy may add data indicating that the prescription has been filled and the particular brand or generic drug with which it was filled. The pharmacy may also bill the patient's insurance according to insurance data contained into the HIE. As this data is updated in the HIE, the HIE may push new or updated data to the embodiment 100 according to data communications rules 102 of the embodiment 100 and recorded in a patient-controlled database 104 thereof. Authorized users 106 of the embodiment may then access the updated data according to predetermined access level permissions as previously described.

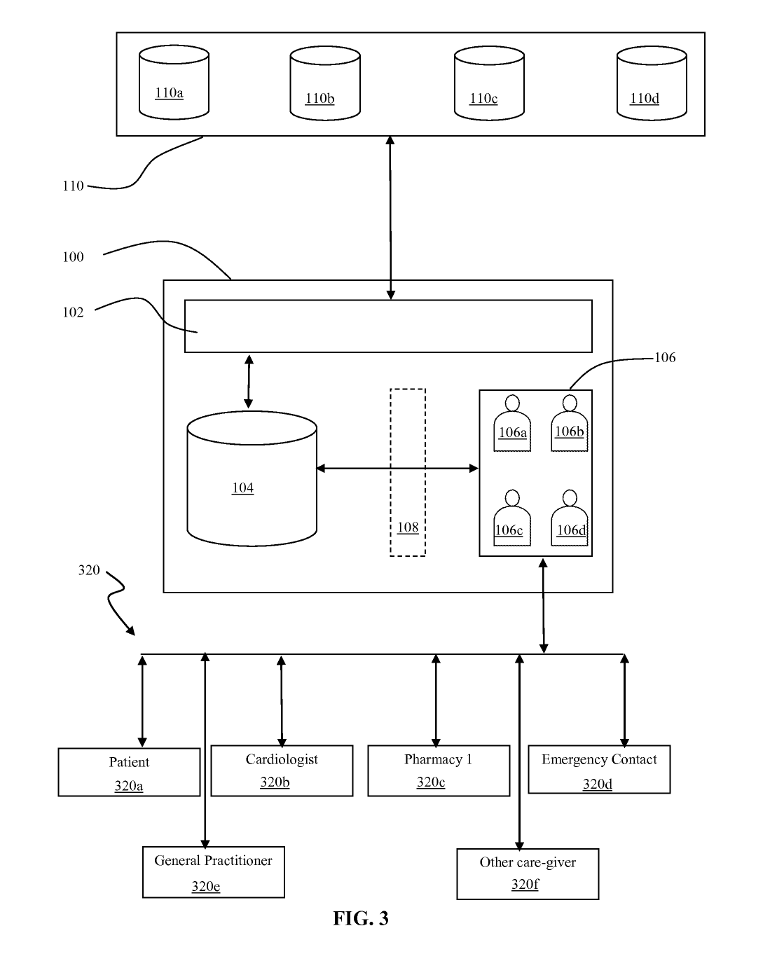

FIG. 3 illustrates examples of the various authorized users 320 who may interact with an embodiment 100. As shown, the patient 320a, the patient's doctors 320b and 320e, his pharmacy 320c, care giver 320f, and emergency contact 320d have been granted access to the embodiment 100 by the patient. According to the schematic view of FIG. 3, each of these authorized users interacts with the embodiment 100 remotely via Internet enabled devices such as those shown in FIG. 1 at reference number 120. Notably, each of these authorized users have different information needs when interacting with the system. Accordingly, an embodiment may include means for limiting access and/or configuring access level permissions for various types of authorized users.

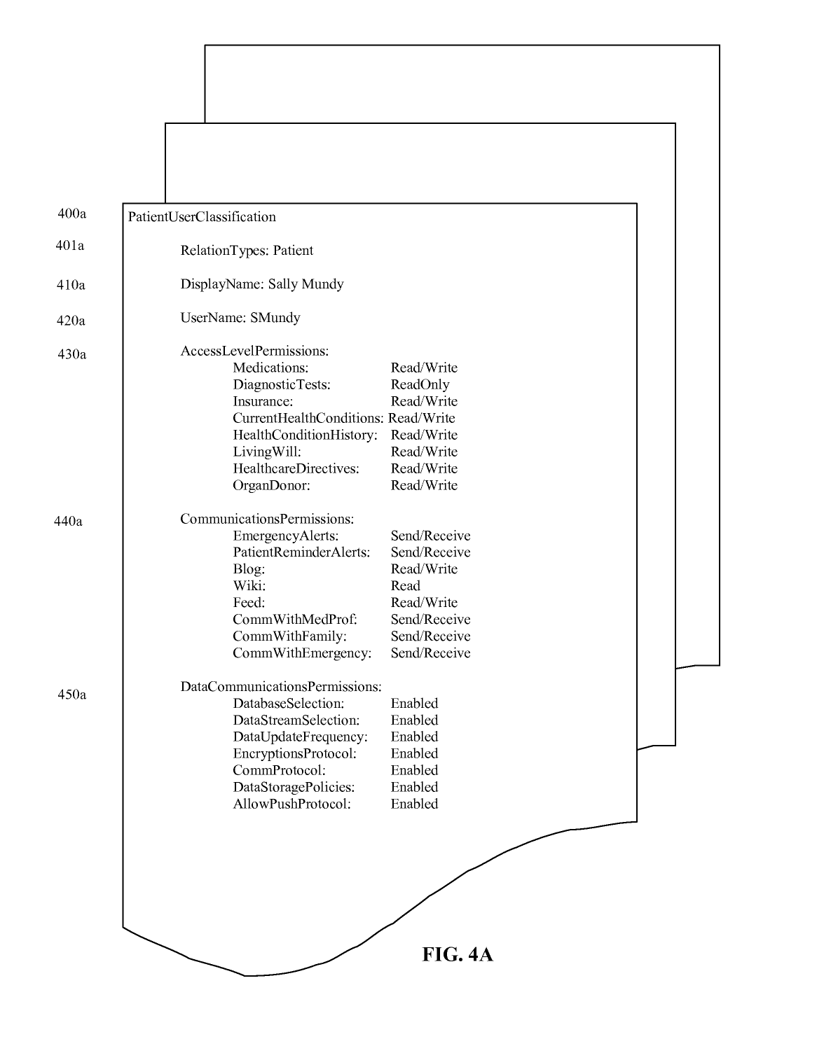

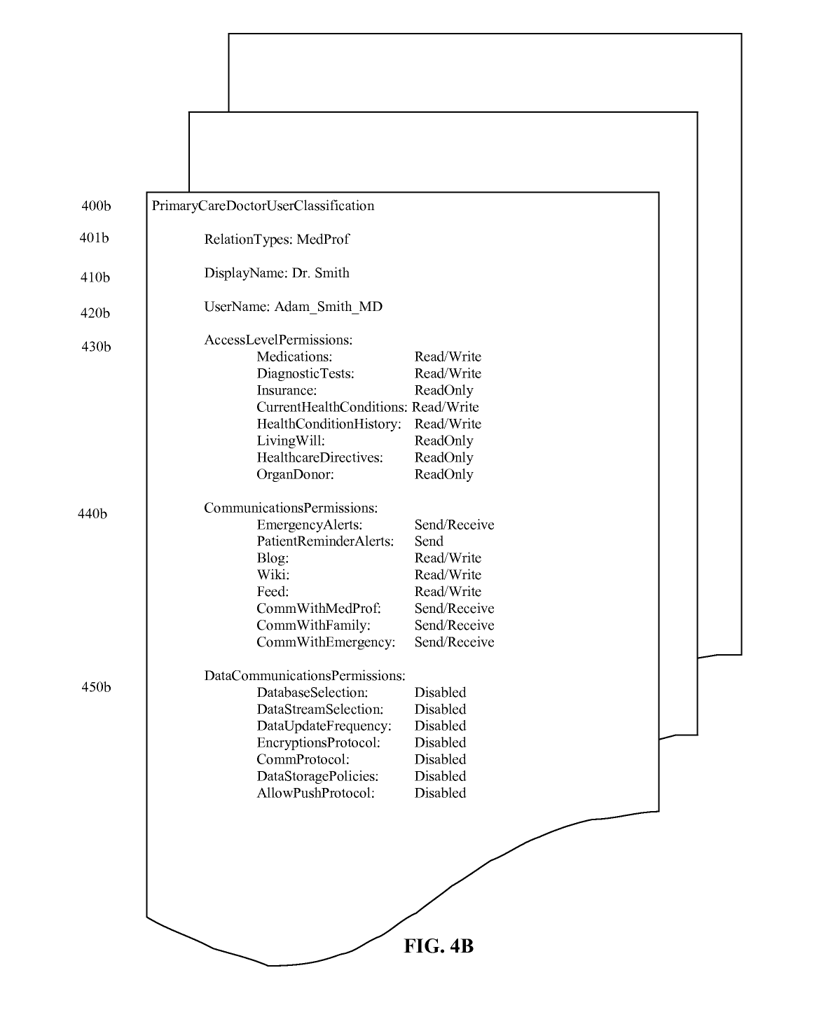

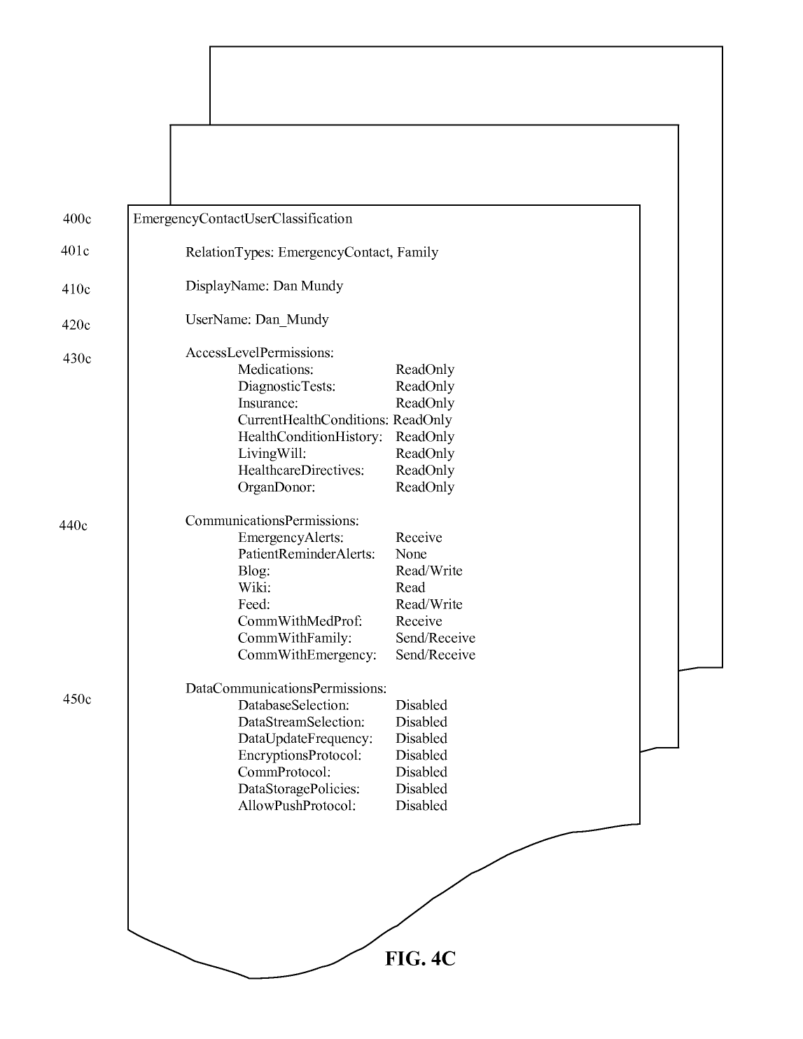

FIG. 4A-4C illustrate a User Classification data structure 400a-c for organizing a set of access level permissions, communications permissions, and system-level data communications permissions. The reference numbers in FIG. 4A-4C indicate lines of the data structure. One skilled in the art will appreciate that the examples set forth here are merely illustrative and not limiting. FIG. 4A illustrates a Patient User Classification 400a, which includes a descriptor 401a indicating the relationship to the patient, a user name 420a for system login, and a user-friendly name which is to be viewable by other authorized users, i.e. the Display Name 410a. Following this, a set of access level permission parameters are set forth at 430a including the ability to read and write various data types including medications, insurance data, current and historical health conditions, healthcare directives and living wills, and organ donor status. Optionally, a patient may have read-only access to medical test data, and therefore may not be able to edit or annotate test data. Again, this is merely illustrative. At 440a a set of communications permissions are set forth which govern how this User Classification communicates with other authorized users. As shown here, the patient is able to send and receive emergency alerts and patient reminder alerts, is able to read and write to the system's blog, wiki, and feed, and is able to communicate with medical professionals, family and emergency contacts. At 450a a set of system-level data communications parameters are set forth which govern the degree to which this User Classification is able to configure system settings affecting the way in which data is communicated to and from third party remote data sources.

In contrast to a Patient User Classification, a Primary Care Doctor User Classification is illustrated in FIG. 4B. The physician has read/write access to medical test data, but read-only access to insurance information, living will, healthcare directives, and organ donor status. Under communications permissions 440b, the physician is able to send patient reminder alerts, but does not receive them. Finally, all of the data communications permissions 450b are set to disabled, so the physician will not have the power to configure the patient-controlled database 104.

An Emergency Contact User Classification is shown in FIG. 4C. This particular emergency contact is both an emergency contact and a family relation of the patient as shown at line 401c. The emergency contact is only able to read data contained in the patient-controlled database 104 as shown at line 430c. According to the communications permissions at line 440c, the emergency contact is permitted to receive but not send emergency alerts, and does not send or receive patient reminder alerts. The emergency contact is also not permitted to initiate communications with medical professionals but is permitted to receive messages from them. Similar to the physician and most other non-patient User Classifications the emergency contact has no power to configure data communications settings 450c.

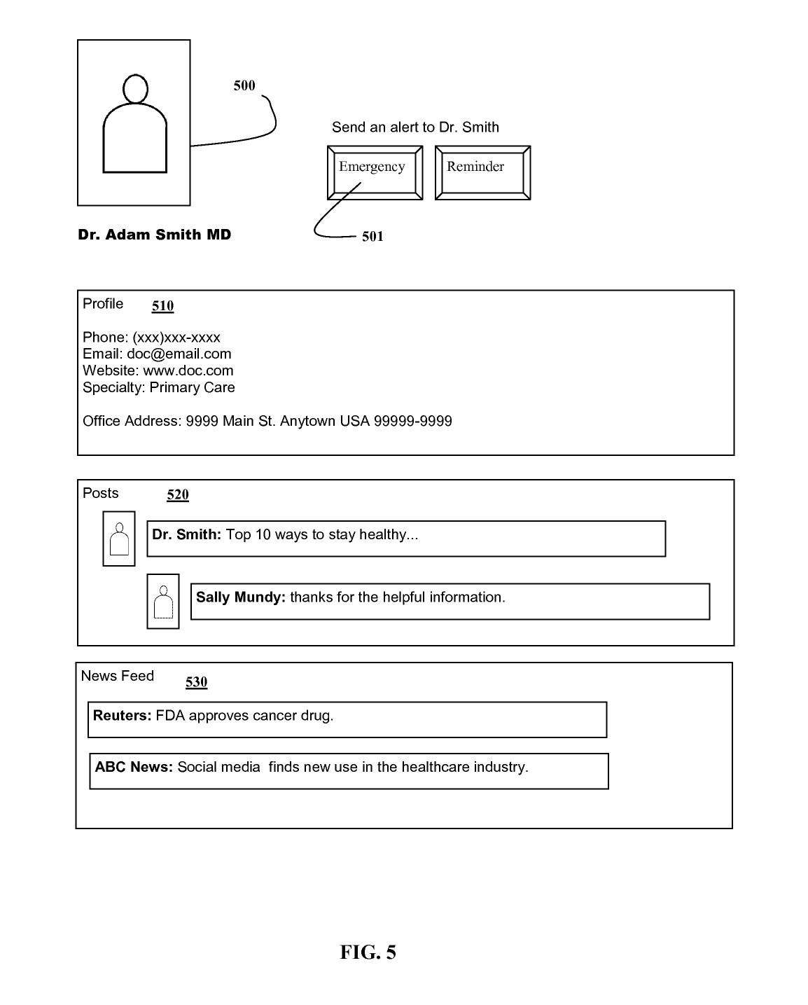

FIG. 5 illustrates a typical profile page equipped with social media tools. Authorized users may be allocated a profile page which they may add content to such as a profile photo 500, and certain profile information 510 such as contact information, and an indication of whether the user is a medical professional, friend, family etc. The user shown in FIG. 5 is doctor and his profile includes controls whereby authorized users having appropriate communications permissions may send alerts to the doctor. If instead, the user was the patient an emergency alert button may be provided which sends an alert to the patient's emergency contact.

With further regard to FIG. 5, in one embodiment authorized users may interact with other authorized users if they share a common patient, or have at least one authorized user in common. However, some embodiments may allow authorized users to connect to one another by issuing an invitation to connect. Upon forming a connection, authorized users may share content, comment on each other's posts, and otherwise interact. In some embodiments, profile pages may include controls to integrate with the patient-controlled database, such as controls for generating reports, reading reports, or manually browsing or searching the database. However, in other embodiments profile pages are maintained separate from database search and retrieval features, and are instead used only for communication between authorized users.

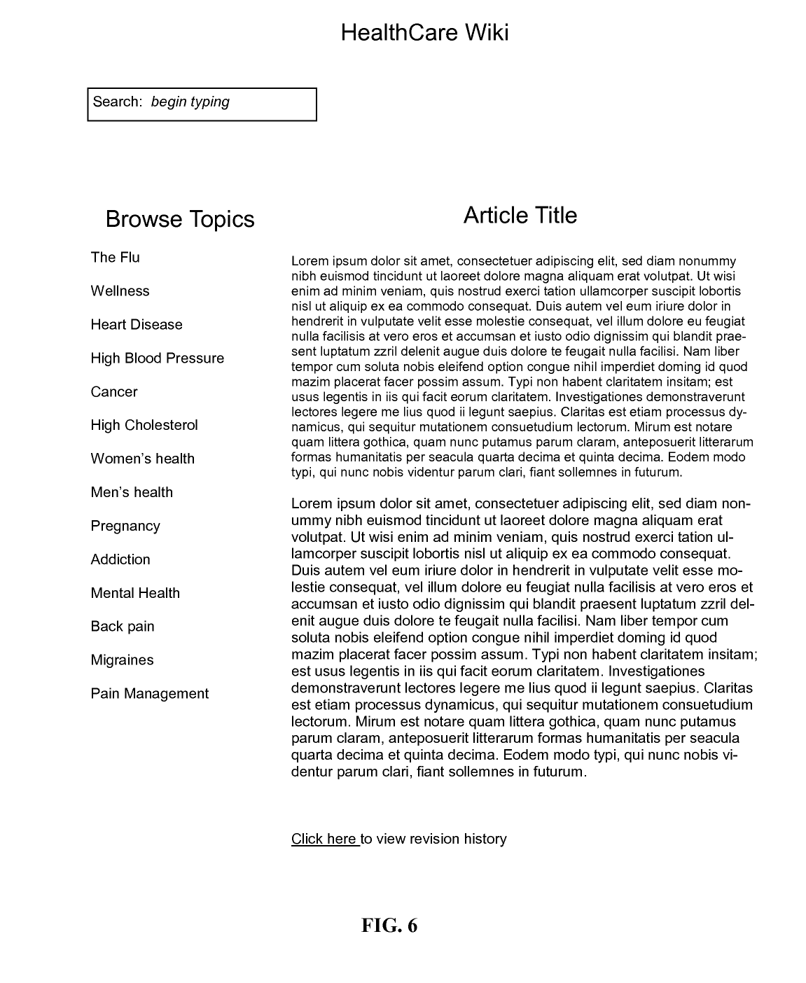

FIG. 6 illustrates a wiki of an embodiment. In some embodiments wiki content may be created and modified only by medical professionals; however, other authorized users may have permission to comment on articles. Still further, a wiki may not be restricted to users associated only with a single patient. Rather, embodiments may comprise many patients each having their own set of authorized users. Thus, in some embodiments authorized users associated with different patients may all have access to the same wiki. Accordingly, multi-patient embodiments may comprise private areas pertaining to a particular patient, and common areas.

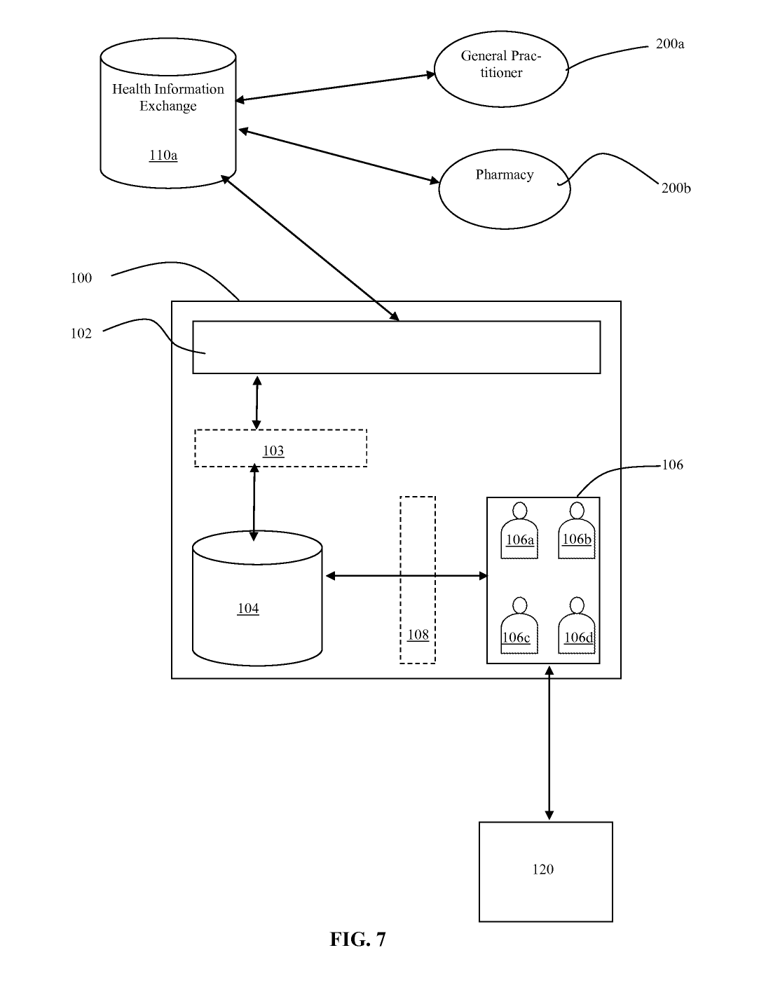

FIG. 7 illustrates a medication reconciliation subsystem 103 of an embodiment. According to FIG. 7, a doctor 200a may prescribe a medication which is recorded in a third party health information exchange 110a. The pharmacy 200b fills the prescription and records the transaction in the HIE 110a. This data is then downloaded to a patient-controlled database 104 according to data communications rules 102. The data is then analyzed according to a set of predetermined medication reconciliation rules 103 to identify errors, unsafe dosages, drug interactions, or other conditions which may be deleterious to the patient. If a problem is found by the medication reconciliation subsystem 103 then an alert may be issued to one or more of the patient, the doctor 200a, the pharmacy 200b, or a caregiver. Embodiments may provide controls for organizing medications to help patients better understand their prescribed therapy.

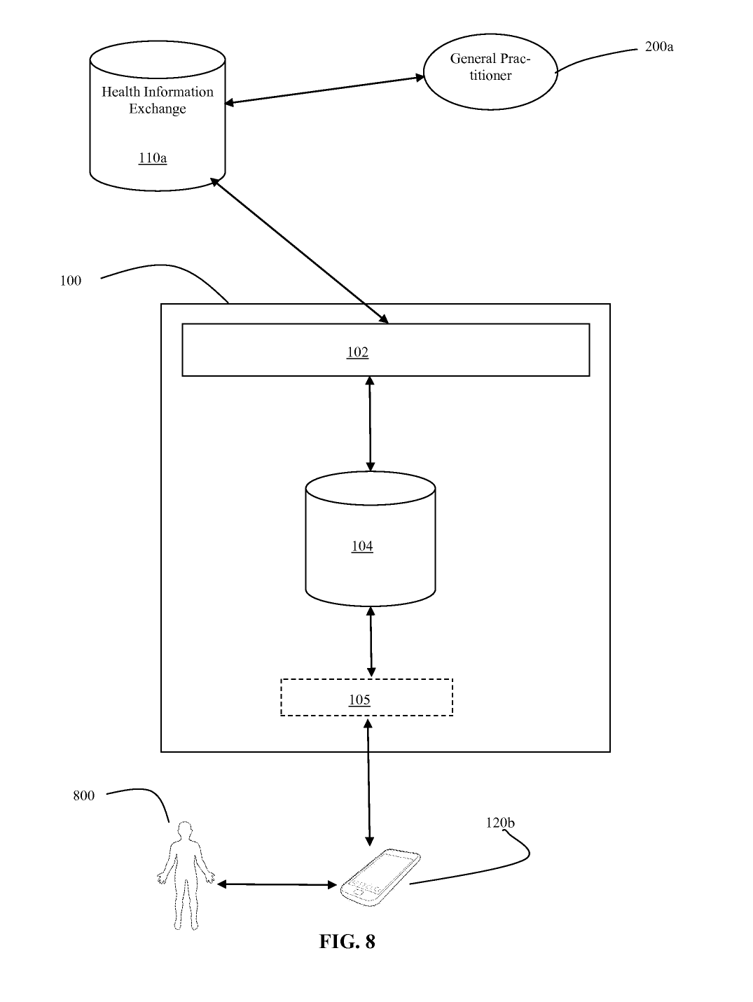

FIG. 8 illustrates an embodiment wherein certain vital signs of a patient 800 are monitored and relayed back to a physician using an Internet enabled device such as a smartphone 120b. According to some embodiments, the process of monitoring may be manual. For instance, a patient or caregiver may measure blood pressure or heart rate etc. at a predetermined interval and input the data into an Internet enabled device 120b which is suitably programmed with an app interfacing with an embodiment. Thus, the data may be recorded in the patient-controlled database 104 and communicated back to the physician 200a. In other embodiments, the process of monitoring may be automated. For instance, a device may be mounted on a patient to continuously monitor a selected vital sign. The device may interface with an Internet enabled device such as a smartphone 120a and similarly record the data in the patient-controlled database 104 and communicated back to the physician 200a. Alternatively, the monitoring device may be Internet enabled and thus may be able to interface with an embodiment directly rather than routing data through a smartphone or personal computer.

It will be apparent to those skilled in the art that the above methods and apparatuses may be changed or modified without departing from the general scope of the invention. The invention is intended to include all such modifications and alterations insofar as they come within the scope of the appended claims or the equivalents thereof.

Having thus described the invention, it is now claimed:

I/We claim:

1. A patient-administered personal healthcare information management system, comprising:
at least one patient-controlled database containing personal healthcare information of a patient, wherein the patient controls the data content of the at least one patient-controlled database;
a patient-controlled means for creating new user accounts;
a set of access level permissions of user accounts adapted to control access of the user accounts to data contained in the at least one patient-controlled database; and
at least one communications feature adapted to allow user accounts to communicate with each other according to a set of predefined communications permissions.

2. The system of claim 1, wherein the user accounts each comprise a User Classification data structure including one or more access level permissions and one or more communications permissions.

3. The system of claim 2, wherein User Classification data structures are grouped into templates according to like sets of access level permissions and according to like sets of communications permissions.

4. The system of claim 1, wherein the set of access level permissions are configurable by the patient.

5. The system of claim 1, further comprising a patient-controlled means for configuring the set of communications permissions.

6. The system of claim 1, wherein the at least one communications feature is selected from one or more of a blog, a wiki, an electronic bulletin board, a profile page adapted to include electronic posts, text chat, SMS text messaging, electronic mail, shareable calendaring software, shareable appointment scheduling software, RSS feeds, video conferencing, voice-over-IP, or conference calling.

7. The system of claim 1, further comprising at least one third party personal healthcare information data source selectable by the patient for placing in electronic data communication with the at least one patient-controlled database, the at least one patient-controlled database being adapted to record and store personal healthcare information data from at least one selected third party personal healthcare information data source.

8. The system of claim 7, wherein the at least one third party personal healthcare information data source comprises a health information exchange service, and wherein the at least one third party personal healthcare information data source comprises a plurality of data streams, the data streams being individually selectable by the patient.

9. The system of claim 1, further comprising a dashboard including selected personal healthcare information data from the at least one patient-controlled database and/or one or more summaries of personal healthcare information data from the database.

10. The system of claim 1, further comprising a means for issuing alert notices to users designated by the patient, wherein alerts may be issued through one or more of a patient user account, non-patient user accounts authorized by the patient to issue alerts, and/or automatically by the system according to predetermined criteria, and wherein the alerts may be received by users authorized by the patient to receive alerts, and/or may be received by users authorized by virtue of their access level permissions to receive alerts.

11. The system of claim 1, further comprising a means for detecting problems with drug prescriptions and reporting the problems to the patient and/or one or more users selected by the patient.

12. The system of claim 11, wherein the means for detecting identifies drug prescription problems by analyzing at least data contained in the patient controlled database.

13. The system of claim 1, further comprising a personal log tool adapted for recording by the patient of health parameters selected from one or more of vital signs, body weight, blood sugar, heart rate, or blood pressure, wherein the personal log tool comprises pre-formatted data fields for receiving data measurable in predetermined units and/or as a function of time.

14. The system of claim 13, wherein the personal log tool is adapted to receive manually inputted data, and/or automatically receive data from an external electronic measuring device according to a predetermined electronic communications protocol.

15. The system of claim 14, wherein the manually or automatically inputted data are recorded in the patient-controlled database and communicated to a physician user account, or to a physician external to the system.

16. The system of claim 1, further comprising a means for providing emergency access to data selected for emergency access according to likely emergency needs.

17. A patient-administered personal healthcare information management system, comprising:
at least one patient-controlled database containing personal healthcare information of a patient, wherein the patient controls the data content of the at least one patient-controlled database;
a patient-controlled means for creating new user accounts;
a set of access level permissions of user accounts adapted to control access of the user accounts to data contained in the at least one patient-controlled database; and
at least one third party personal healthcare information data source selectable by the patient for placing in electronic data communication with the at least one patient-controlled database, the at least one patient-controlled database being adapted to record and store personal healthcare information data from at least one selected third party personal healthcare information data source.

18. The system of claim 17, wherein the at least one third party personal healthcare information data source comprises a health information exchange service, and wherein the at least one third party personal healthcare information data source comprises a plurality of data streams, the data streams being individually selectable by the patient.

19. The system of claim 17, wherein the user accounts each comprise a user classification data structure including one or more access level permissions and one or more communications permissions.

20. The system of claim 19, wherein user classification data structures are grouped into templates according to like sets of access level permissions and according to like sets of communications permissions.

21. The system of claim 17, wherein the set of access level permissions are configurable by the patient.

22. The system of claim 17, further comprising a patient-controlled means for configuring the set of communications permissions.

23. The system of claim 17, wherein the at least one communications feature is selected from one or more of a blog, a wild, an electronic bulletin board, a profile page adapted to include electronic posts, text chat, SMS text messaging, electronic mail, shareable calendaring software, shareable appointment scheduling software, RSS feeds, video conferencing, voice-over-IP, or conference calling.

24. The system of claim 17, further comprising a dashboard including selected personal healthcare information data from the at least one patient-controlled database and/or one or more summaries of personal healthcare information data from the database.

25. The system of claim 17, further comprising a means for issuing alert notices to users designated by the patient, wherein alerts may be issued through one or more of a patient user account, non-patient user accounts authorized by the patient to issue alerts, and/or automatically by the system according to predetermined criteria, and wherein the alerts may be received by users authorized by the patient to receive alerts, and/or may be received by users authorized by virtue of their access level permissions to receive alerts.

26. The system of claim 17, further comprising a means for detecting problems with drug prescriptions and reporting the problems to the patient and/or one or more users selected by the patient.

27. The system of claim 26, wherein the means for detecting identifies drug prescription problems by analyzing at least data contained in the patient controlled database.

28. The system of claim 17, further comprising a personal log tool adapted for recording by the patient of health parameters selected from one or more of vital signs, body weight, blood sugar, heart rate, or blood pressure, wherein the personal log tool comprises pre-formatted data fields for receiving data measurable in predetermined units and/or as a function of time.

29. The system of claim 28, wherein the personal log tool is adapted to receive manually inputted data, and/or automatically receive data from an external electronic measuring device according to a predetermined electronic communications protocol.

30. The system of claim 29, wherein the manually or automatically inputted data are recorded in the patient-controlled database and communicated to a physician user account, or to a physician external to the system.

31. The system of claim 17, further comprising a means for providing emergency access to data selected for emergency access according to likely emergency needs.

32. A patient-administered personal healthcare information management system, comprising:
at least one patient-controlled database containing personal healthcare information of a patient, wherein the patient controls the data content of the at least one patient-controlled database;
a patient-controlled means for creating new user accounts;
a set of access level permissions of user accounts adapted to control access of the user accounts to data contained in the at least one patient-controlled database; and
a personal log tool adapted for recording by the patient of health parameters selected from one or more of vital signs, body weight, blood sugar, heart rate, or blood pressure, wherein the personal log tool comprises pre-formatted data fields for receiving data measurable in predetermined units and/or as a function of time.

33. The system of claim 32, wherein the personal log tool is adapted to receive manually inputted data, and/or automatically receive data from an external electronic measuring device according to a predetermined electronic communications protocol.

34. The system of claim 33, wherein the manually or automatically inputted data are recorded in the patient-controlled database and communicated to a physician user account, or to a physician external to the system.

35. The system of claim 32, wherein the user accounts each comprise a user classification data structure including one or more access level permissions and one or more communications permissions.

36. The system of claim 35, wherein user classification data structures are grouped into templates according to like sets of access level permissions and according to like sets of communications permissions.

37. The system of claim 32, wherein the set of access level permissions are configurable by the patient.

38. The system of claim 32, further comprising a patient-controlled means for configuring the set of communications permissions.

39. The system of claim 32, wherein the at least one communications feature is selected from one or more of a blog, a wiki, an electronic bulletin board, a profile page adapted to include electronic posts, text chat, SMS text messaging, electronic mail, shareable calendaring software, shareable appointment scheduling software, RSS feeds, video conferencing, voice-over-IP, or conference calling.

40. The system of claim 32, further comprising at least one third party personal healthcare information data source selectable by the patient for placing in electronic data communication with the at least one patient-controlled database, the at least one patient-controlled database being adapted to record and store personal healthcare information data from at least one selected third party personal healthcare information data source.

41. The system of claim 40, wherein the at least one third party personal healthcare information data source comprises a health information exchange service, and wherein the at least one third party personal healthcare information data source comprises a plurality of data streams, the data streams being individually selectable by the patient.

42. The system of claim 32, further comprising a dashboard including selected personal healthcare information data from the at least one patient-controlled database and/or one or more summaries of personal healthcare information data from the database.

43. The system of claim 32, further comprising a means for issuing alert notices to users designated by the patient, wherein alerts may be issued through one or more of a patient user account, non-patient user accounts authorized by the patient to issue alerts, and/or automatically by the system according to predetermined criteria, and wherein the alerts may be received by users authorized by the patient to receive alerts, and/or may be received by users authorized by virtue of their access level permissions to receive alerts.

44. The system of claim 32, further comprising a means for detecting problems with drug prescriptions and reporting the problems to the patient and/or one or more users selected by the patient.

45. The system of claim 44, wherein the means for detecting identifies drug prescription problems by analyzing at least data contained in the patient controlled database.

46. The system of claim 32, further comprising a means for providing emergency access to data selected for emergency access according to likely emergency needs.

47. A patient-administered personal healthcare information management system, comprising:
at least one patient-controlled database containing personal healthcare information of a patient, wherein the patient controls the data content of the at least one patient-controlled database;
a patient-controlled means for creating new user accounts;
a set of access level permissions of user accounts adapted to control access of the user accounts to data contained in the at least one patient-controlled database; and
a means for detecting problems with drug prescriptions and reporting the problems to the patient and/or one or more users selected by the patient.

48. The system of claim 47, wherein the means for detecting identifies drug prescription problems by analyzing at least data contained in the patient controlled database.

49. The system of claim 47, wherein the user accounts each comprise a user classification data structure including one or more access level permissions and one or more communications permissions.

50. The system of claim 49, wherein user classification data structures are grouped into templates according to like sets of access level permissions and according to like sets of communications permissions.

51. The system of claim 47, wherein the set of access level permissions are configurable by the patient.

52. The system of claim 47, further comprising a patient-controlled means for configuring the set of communications permissions.

53. The system of claim 47, wherein the at least one communications feature is selected from one or more of a blog, a wiki, an electronic bulletin board, a profile page adapted to include electronic posts, text chat, SMS text messaging, electronic mail, shareable calendaring software, shareable appointment scheduling software, RSS feeds, video conferencing, voice-over-IP, or conference calling.

54. The system of claim 47, further comprising at least one third party personal healthcare information data source selectable by the patient for placing in electronic data communication with the at least one patient-controlled database, the at least one patient-controlled database being adapted to record and store personal healthcare information data from at least one selected third party personal healthcare information data source.

55. The system of claim 54, wherein the at least one third party personal healthcare information data source comprises a health information exchange service, and wherein the at least one third party personal healthcare information data source comprises a plurality of data streams, the data streams being individually selectable by the patient.

56. The system of claim 47, further comprising a dashboard including selected personal healthcare information data from the at least one patient-controlled database and/or one or more summaries of personal healthcare information data from the database.

57. The system of claim 47, further comprising a means for issuing alert notices to users designated by the patient, wherein alerts may be issued through one or more of a patient user account, non-patient user accounts authorized by the patient to issue alerts, and/or automatically by the system according to predetermined criteria, and wherein the alerts may be received by users authorized by the patient to receive alerts, and/or may be received by users authorized by virtue of their access level permissions to receive alerts.

58. The system of claim 47, further comprising a personal log tool adapted for recording by the patient of health parameters selected from one or more of vital signs, body weight, blood sugar, heart rate, or blood pressure, wherein the personal log tool comprises pre-formatted data fields for receiving data measurable in predetermined units and/or as a function of time.

59. The system of claim 58, wherein the personal log tool is adapted to receive manually inputted data, and/or automatically receive data from an external electronic measuring device according to a predetermined electronic communications protocol.

60. The system of claim 59, wherein the manually or automatically inputted data are recorded in the patient-controlled database and communicated to a physician user account, or to a physician external to the system.

61. The system of claim 47, further comprising a means for providing emergency access to data selected for emergency access according to likely emergency needs.

62. A patient-administered personal healthcare information management system, comprising:
at least one patient-controlled database containing personal healthcare information of a patient, wherein the patient controls the data content of the at least one patient-controlled database;
a patient-controlled means for creating new user accounts;
a set of access level permissions of user accounts adapted to control access of the user accounts to data contained in the at least one patient-controlled database;
at least one communications feature adapted to allow user accounts to communicate with each other according to a set of predefined communications permissions;
at least one third party personal healthcare information data source selectable by the patient for placing in electronic data communication with the at least one patient-controlled database, the at least one patient-controlled database being adapted to record and store personal healthcare information data from at least one selected third party personal healthcare information data source;
a personal log tool adapted for recording by the patient of health parameters selected from one or more of vital signs, body weight, blood sugar, heart rate, or blood pressure, wherein the personal log tool comprises pre-formatted data fields for receiving data measurable in predetermined units and/or as a function of time, wherein the personal log tool is adapted to receive manually inputted data, and/or automatically receive data from an external electronic measuring device according to a predetermined electronic communications protocol; and
a means for detecting problems with drug prescriptions and reporting the problems to the patient and/or one or more users selected by the patient.
